(19) United States
(12) Patent Application Publication
(10) Pub. No.: US 2026/0109790 A1
(43) Pub. Date: Apr. 23, 2026

(54) COMPOSITIONS INCLUDING ZIRCONIUM METAL-LIGAND COMPLEXES AND NONMETALLOCENE COMPLEXES

(71) Applicant: Dow Global Technologies LLC, Midland, MI (US)

(72) Inventors: Angela I. Padilla-Acevedo, Bartlesville, OK (US); Rujul Mehta, Manvel, TX (US); Timothy R. Lynn, Glen Gardner, NJ (US); John F. Szul, Fayetteville, WV (US); Cliff R. Mure, Hillsborough, NJ (US); Chuan C. He, Missouri City, TX (US); Evelyn Auyeung, Houston, TX (US)

(21) Appl. No.: 19/153,371

(22) PCT Filed: Jan. 15, 2025
(86) PCT No.: PCT/US2025/011618

§ 371 Date: Aug. 4, 2025

Related U.S. Application Data
(60) Provisional application No. 63/554,723, filed on Feb. 16, 2024.

(51) Int. Cl. C08F 4/659

(52) U.S. Cl. CPC C08F 4/65916

(57) ABSTRACT

Embodiments of the present disclosure directed towards compositions including zirconium metal-ligand complexes and non-metallocene complexes.

### FIELD OF DISCLOSURE

Embodiments of the present disclosure are directed towards compositions including zirconium metal-ligand complexes and non-metallocene complexes.

### BACKGROUND

Polymers may be utilized for a number of products including pipes, among others. Polymers can be formed by reacting one or more types of monomer in a polymerization reaction. There is continued focus in the industry on developing new and improved materials and/or processes that may be utilized to form polymers.

### SUMMARY

The present disclosure provides various embodiments, including:

A composition for making a bimodal polyolefin polymer including a zirconium metal-ligand complex of Formula I:

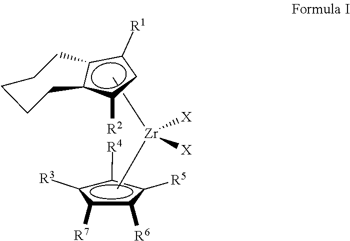

wherein R¹ and R² are each independently a (C₁-C₈)alkyl, and R³, R⁴, R⁵, R⁶, R⁷ are each independently H or a (C₁-C₈)alkyl, with the proviso that at least one of R³, R⁴, R⁵, R⁶, R⁷ is a (C₁-C₈)alkyl; and each X is independently a leaving group; a non-metallocene complex; an activator; and a support.

### DETAILED DESCRIPTION

Zirconium (Zr) metal-ligand complexes are discussed herein. The Zr metal-ligand complexes can be represented by Formula I

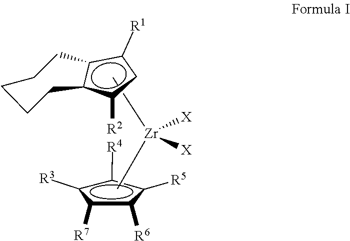

wherein R¹ and R² are each independently a (C₁-C₈)alkyl, and R³, R⁴, R⁵, R⁶, R⁷ are each independently H or a (C₁-C₈)alkyl, with the proviso that at least one of R³, R⁴, R⁵, R⁶, R⁷ is a (C₁-C₈)alkyl; and each X is independently a leaving group. The Zr metal-ligand complexes of Formula I may be referred to as metallocene complexes.

Advantageously, these Zr metal-ligand complexes and non-metallocene complexes discussed further herein can be utilized in compositions for making bimodal polymers, e.g., a polyolefin polymer characterized by a bimodal molecular weight distribution. One or more embodiments provide that the Zr metal-ligand complex of Formula I is utilized as a trim catalyst. In other words, one or more embodiments provide that the Zr metal-ligand complex of Formula I is unsupported. For instance, the Zr metal-ligand complex of Formula I can be utilized to make a trim catalyst solution. Trim catalyst solutions are known. The trim catalyst solution can include a hydrocarbon. Examples of the hydrocarbon include hexane, isopentane, and combinations thereof, among other hydrocarbons. Different amounts of the hydrocarbon can be utilized for various applications.

The unsupported Zr metal-ligand complex of Formula I, e.g., the trim catalyst solution, can be injected into a fluidized bed-gas phase polymerization (FB-GPP) reactor, along with other polymerization components discussed herein, such as a supported non-metallocene complex represented by Formula II, discussed further herein, to make bimodal polymers.

These compositions including the Zr metal-ligand complex and the non-metallocene complex can be utilized to make bimodal polymers having an improved, i.e., reduced, total oligomer, as compared to polymers formed with other metallocenes (non-inventive) at similar polymerization conditions. These bimodal polymers are desirable for a number of applications, including pipes, for instance.

As mentioned, embodiments provide that R¹ and R² are each independently a (C₁-C₈)alkyl, and R³, R⁴, R⁵, R⁶, R⁷ are each independently H or a (C₁-C₈)alkyl, with the proviso that at least one of R³, R⁴, R⁵, R⁶, R⁷ is a (C₁-C₈)alkyl. In other words, embodiments provide that each of R³, R⁴, R⁵, R⁶, R⁷ are not H. One or more embodiments of the present disclosure provide that R¹ and R² are each independently a (C₁-C₇)alkyl. One or more embodiments of the present disclosure provide that R¹ and R² are each independently a (C₁-C₆)alkyl. One or more embodiments of the present disclosure provide that R¹ and R² are each independently a (C₁-C₅)alkyl. One or more embodiments of the present disclosure provide that R¹ and R² are each independently a (C₁-C₄)alkyl. One or more embodiments of the present disclosure provide that R¹ and R² are each independently a (C₁-C₃)alkyl. One or more embodiments of the present disclosure provide that R¹ and R² are each independently a (C₁-C₂)alkyl. One or more embodiments of the present disclosure provide that R¹ and R² are each independently a (C₁)alkyl. One or more embodiments of the present disclosure provide that R¹ and R² are identical. For instance, R¹ and R² can each be (C₃)alkyl, a (C₂)alkyl, or a (C₁)alkyl.

As mentioned, embodiments provide that R³, R⁴, R⁵, R⁶, R⁷ are each independently H or a (C₁-C₈)alkyl, with the proviso that at least one of R³, R⁴, R⁵, R⁶, R⁷ is a (C₁-C₈) alkyl. One or more embodiments of the present disclosure provide that R³, R⁴, R⁵, R⁶, R⁷ are each independently H or a (C₁-C₈)alkyl, with the proviso that at least two of R³, R⁴, R⁵, R⁶, R⁷ is a (C₁-C₈)alkyl. One or more embodiments of the present disclosure provide that R³, R⁴, R⁵, R⁶, R⁷ are each independently H or a (C₁-C₈)alkyl, with the proviso that at least three of R³, R⁴, R⁵, R⁶, R⁷ is a (C₁-C₈) alkyl. One or more embodiments of the present disclosure provide that R³, R⁴, R⁵, R⁶, R⁷ are each independently H or a (C₁-C₈)alkyl, with the proviso that at least four of R³, R⁴, R⁵, R⁶, R⁷ is a (C₁-C₈) alkyl.

One or more embodiments of the present disclosure provide that R¹ and R² are each independently a (C₁-C₃)alkyl and R³, R⁴, R⁵, R⁶, R⁷ are each independently H or a (C₁-C₃)alkyl, with the proviso that at least one of R³, R⁴, R⁵, R⁶, R⁷ is a (C₁-C₃)alkyl. One or more embodiments of the present disclosure provide that R¹ and R² are each independently a (C₁-C₃)alkyl and R³, R⁴, R⁵, R⁶, R⁷ are each independently H or a (C₁-C₃)alkyl, with the proviso that at only one of R³, R⁴, R⁵, R⁶, R⁷ is a (C₁-C₃)alkyl. One or more embodiments of the present disclosure provide that R¹ and R² are each independently a (C₁)alkyl and R³, R⁴, R⁵, R⁶, R⁷ are each independently H or a (C₁)alkyl, with the proviso that at only one of R³, R⁴, R⁵, R⁶, R⁷ is a (C₁)alkyl.

Embodiments of the present disclosure provide that each X is a leaving group. One or more embodiments provide that X is selected from alkyls, aryls, hydridos, and halogens. One or more embodiments provide that X is selected from a halogen, (C₁-C₅)alkyl, CH₂SiMe₃, and benzyl. One or more embodiments provide that X is selected from alkyls and halogens. One or more embodiments provide that X is Cl. One or more embodiments provide that X is methyl.

Examples of X include halogen ions, hydrides, (C₁ to C₁₂)alkyls, (C₂ to C₁₂)alkenyls, (C₆ to C₁₂)aryls, (C₇ to C₂₀)alkylaryls, (C₁ to C₁₂)alkoxys, (C₆ to C₁₆)aryloxys, (C₇ to C₈)alkylaryloxys, (C₁ to C₁₂)fluoroalkyls, (C₆ to C₁₂)fluoroaryls, and (C₁ to C₁₂)heteroatom-containing hydrocarbons and substituted derivatives thereof; one or more embodiments include hydrides, halogen ions, (C₁ to C₆)alkyls, (C₂ to C₆) alkenyls, (C₇ to C₁₈)alkylaryls, (C₁ to C₆)alkoxys, (C₆ to C₁₄)aryloxys, (C₇ to C₁₆) alkylaryloxys, (C₁ to C₆)alkylcarboxylates, (C₁ to C₆)fluorinated alkylcarboxylates, (C₆ to C₁₂)arylcarboxylates, (C₇ to C₁₈)alkylarylcarboxylates, (C₁ to C₆)fluoroalkyls, (C₂ to C₆)fluoroalkenyls, and (C₇ to C₁₈)fluoroalkylaryls; one or more embodiments include hydride, chloride, fluoride, methyl, phenyl, phenoxy, benzoxy, tosyl, fluoromethyls and fluorophenyls; one or more embodiments include (C₁ to C₁₂)alkyls, (C₂ to C₁₂)alkenyls, (C₆ to C₁₂)aryls, (C₇ to C₂₀)alkylaryls, substituted (C₁ to C₁₂)alkyls, substituted (C₆ to C₁₂)aryls, substituted (C₇ to C₂₀)alkylaryls, and (C₁ to C₁₂)heteroatom-containing alkyls, (C₁ to C₁₂)heteroatom-containing aryls, and (C₁ to C₁₂)heteroatom-containing alkylaryls; one or more embodiments include chloride, fluoride, (C₁ to C₆)alkyls, (C₂ to C₆)alkenyls, (C₇ to C₁₈)alkylaryls, halogenated (C₁ to C₆)alkyls, halogenated (C₂ to C₆) alkenyls, and halogenated (C₇ to C₁₈)alkylaryls; one or more embodiments include fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls).

Other non-limiting examples of X groups include amines, phosphines, ethers, carboxylates, dienes, hydrocarbon radicals having from 1 to 20 carbon atoms, fluorinated hydrocarbon radicals, e.g., —C₆F₅ (pentafluorophenyl), fluorinated alkylcarboxylates, e.g., CF₃C(O)O—, hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, and dimethylphosphide radicals, among others. In one embodiment, two or more X's form a part of a fused ring or ring system. In one or more embodiments, X can be a leaving group selected from the group consisting of chloride ions, bromide ions, (C₁ to C₁₀)alkyls, (C₂ to C₁₂)alkenyls, carboxylates, acetylacetonates, and alkoxides. In one or more embodiments, X is methyl.

One or more embodiments provide that the Zr metal ligand-complex can be (methyl cyclopentadienyl)(1,3-dimethyl hexahydroazulenyl) zirconium dimethyl. (Methyl cyclopentadienyl)(1,3-dimethyl hexahydroazulenyl) zirconium dimethyl can be represented by the following Formula III:

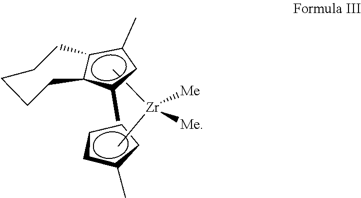

As shown in the above Formula representing (methyl cyclopentadienyl)(1,3-dimethyl hexahydroazulenyl) zirconium dimethyl, the upper cyclopentadienyl ring is substituted with two (C₁)alkyls and is bonded to another ring, i.e. the upper component is bicyclic, and the lower cyclopentadienyl ring is substituted with one (C₁)alkyl. As the cyclopentadienyl components, e.g., the upper and lower components illustrated above, are not identical, the complex can be referred to as an asymmetrical complex, e.g., an asymmetrical metallocene. As shown in the above Formula representing (methyl cyclopentadienyl)(1,3-dimethyl hexahydroazulenyl) zirconium dimethyl, R¹ and R², as discussed herein, are each (C₁)alkyls, R³, R⁴, R⁵, R⁶, R⁷ are each independently H or a (C₁)alkyl, with the proviso that at only one of R³, R⁴, R⁵, R⁶, R⁷ is a (C₁)alkyl and X, as discussed herein, is methyl (Me).

The Zr metal ligand-complexes discussed herein can be made by contacting a Zr complex with an alkali metal complex to make the a Zr metal ligand-complex. The Zr metal ligand-complexes discussed herein can be made by processes, e.g., with conventional solvents, reaction conditions, reaction times, and isolation procedures, utilized for making known metallocenes. The Zr metal-ligand complexes represented by Formula I are known.

As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, an “alkyl” includes linear, branched and cyclic paraffin radicals that are deficient by one hydrogen. Thus, for example, CH₃ (“methyl”) and CH₂CH₃ (“ethyl”) are examples of alkyls.

The Zr metal ligand-complex can be utilized in compositions for making bimodal polymers, for instance. The compositions, as disclosed herein, for making bimodal polymers can include the Zr metal ligand-complex, a non-metallocene complex, an activator, and a support. Embodiments provide that one or more of the Zr metal ligand-complex, the non-metallocene complex, and the activator, can be supported on the same or separate supports.

Embodiments of the present disclosure provide that the non-metallocene complex can be represented by Formula II

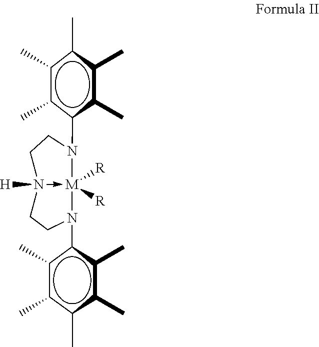

wherein M is Zr or Hf and each R independently is Cl, Br, a (C₁ to C₂₀) alkyl, a (C₁ to C₆) alkyl-substituted (C₆-C₁₂) aryl, benzyl, or a (C₁ to C₆) alkyl-substituted benzyl.

One or more embodiments provide that R is benzyl. One or more embodiments provide that the non-metallocene complex represented by Formula II is bis(2-(pentamethylphenylamido)ethyl)-amine zirconium dibenzyl.

Non-metallocene complexes represented by Formula II are known. The non-metallocene complexes represented by Formula II can be made by processes, i.e. with conventional solvents, reaction conditions, reaction times, and isolation procedures, utilized for making non-metallocene complexes represented by Formula II. The non-metallocene complexes represented by Formula II can be obtained commercially.

Embodiments provide that the Zr metal ligand-complex of Formula I can be from 20 to 80 weight percent of the composition based upon a total weight of the Zr metal-ligand complex of Formula I and the non-metallocene complex Formula II. All individual values and subranges from 20 to 80 weight percent are included; for example, the Zr metal ligand-complex of Formula I can be from a lower limit of 20, 35, or 40 wt % to an upper limit of 80, 75, or 70 wt % of the composition based upon a total weight of the Zr metal-ligand complex of Formula I and the non-metallocene complex of Formula II.

Embodiments provide that the non-metallocene complex can be from 20 to 80 weight percent of the composition based upon a total weight of the Zr metal-ligand complex of Formula I and the non-metallocene complex of Formula II. All individual values and subranges from 20 to 80 weight percent are included; for example, the non-metallocene complex can be from a lower limit of 20, 35, or 40 wt % to an upper limit of 80, 75, or 60 wt % of the composition based upon the total weight of the Zr metal-ligand complex of Formula I and the non-metallocene complex of Formula II.

As mentioned, the compositions for making bimodal polymers can include an activator. As used herein, “activator” refers to any compound or combination of compounds, supported, or unsupported, which can activate a complex, such as the Zr metal-ligand complex of Formula I and/or the non-metallocene complex of Formula II, or a catalyst component, such as by creating a cationic species of the catalyst component. For example, this can include the abstraction of at least one leaving group, e.g., the “X” group described herein, from the metal center of the complex/catalyst component, e.g. the Zr metal-ligand complex of Formula I. The activator may also be referred to as a “co-catalyst”. As used herein, “leaving group” refers to one or more chemical moieties bound to a metal atom and that can be abstracted by an activator, thus producing a species active towards olefin polymerization.

A polymerization catalyst can be made by contacting, under activating conditions, the Zr metal-ligand complex of Formula I and/or the non-metallocene complex of Formula II and an activator to provide the polymerization catalyst, e.g. an activated Zr metal-ligand complex of Formula I and/or an activated non-metallocene complex of Formula II. Activating conditions are well known in the art.

The activator can include a Lewis acid or a non-coordinating ionic activator or ionizing activator, or any other compound including Lewis bases, aluminum alkyls, and/or conventional-type co-catalysts. In addition to methylaluminoxane (“MAO”) and modified methylaluminoxane (“MMAO”) mentioned above, illustrative activators can include, but are not limited to, aluminoxane or modified aluminoxane, and/or ionizing compounds, neutral or ionic, such as dimethylanilinium tetrakis(pentafluorophenyl)borate, triphenylcarbenium tetrakis(pentafluorophenyl)borate, dimethylanilinium tetrakis(3,5-(CF₃)₂phenyl)borate, triphenylcarbenium tetrakis(3,5-(CF₃)₂phenyl)borate, dimethylanilinium tetrakis(perfluoronapthyl)borate, triphenylcarbenium tetrakis(perfluoronapthyl)borate, dimethylanilinium tetrakis(pentafluorophenyl)aluminate, triphenylcarbenium tetrakis(pentafluorophenyl)aluminate, dimethylanilinium tetrakis(perfluoronapthyl)aluminate, triphenylcarbenium tetrakis(perfluoronapthyl)aluminate, a tris(perfluorophenyl)boron, a tris(perfluoronaphthyl)boron, tris(perfluorophenyl)aluminum, a tris(perfluoronaphthyl)aluminum or any combinations thereof.

Aluminoxanes can be described as oligomeric aluminum compounds having -A1(A²)-O— subunits, where A² is an alkyl group. Examples of aluminoxanes include, but are not limited to, methylaluminoxane (“MAO”), modified methylaluminoxane (“MMAO”), ethylaluminoxane, isobutylaluminoxane, or a combination thereof. Aluminoxanes can be produced by the hydrolysis of the respective trialkylaluminum compound. MMAO can be produced by the hydrolysis of trimethylaluminum and a higher trialkylaluminum, such as triisobutylaluminum. There are a variety of known methods for preparing aluminoxane and modified aluminoxanes. The aluminoxane can include a modified methyl aluminoxane (“MMAO”) type 3A (commercially available from Akzo Chemicals, Inc. under the trade name Modified Methylaluminoxane type 3A, discussed in U.S. Pat. No. 5,041,584). A source of MAO can be a solution having from about 1 wt. % to about a 50 wt. % MAO, for example. Commercially available MAO solutions can include the 10 wt. % and 30 wt. % MAO solutions available from Albemarle Corporation.

One or more organo-aluminum compounds, such as one or more alkylaluminum compound, can be used in conjunction with the aluminoxanes. Examples of alkylaluminum compounds include, but are not limited to, diethylaluminum ethoxide, diethylaluminum chloride, diisobutylaluminum hydride, and combinations thereof. Examples of other alkylaluminum compounds, e.g., trialkylaluminum compounds include, but are not limited to, trimethylaluminum, triethylaluminum (“TEAL”), triisobutylaluminum (“TiBAl”), tri-n-hexylaluminum, tri-n-octylaluminum, tripropylaluminum, tributylaluminum, and combinations thereof.

One or more embodiments provide that a molar ratio of metal, e.g., aluminum, in the activator to Group IV metal, e.g. Zr and/or Hf, in the Zr metal-ligand complex of Formula I and the non-metallocene complex of Formula II may be 1500:1 to 0.5:1, 300:1 to 1:1, or 150:1 to 1:1. One or more embodiments provide that the molar ratio of metal in the activator to Group IV metal in the Zr metal-ligand complex of Formula I and the non-metallocene complex of Formula II is at least 75:1. One or more embodiments provide that the molar ratio of metal in the activator to Group IV metal in the Zr metal-ligand complex of Formula I and the non-metallocene complex of Formula II is at least 100:1. One or more embodiments provide that the molar ratio of metal in the activator to Group IV metal in the Zr metal-ligand complex of Formula I and the non-metallocene complex of Formula II is at least 150:1.

As mentioned, the compositions for making bimodal polymers can include a support. A “support”, which may also be referred to as a “carrier”, refers to any support material, including a porous support material, such as talc, inorganic oxides, and inorganic chlorides. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

A number of polymerization components discussed herein, such as the Zr metal-ligand complex of Formula I and/or the non-metallocene complex represented by Formula II, can be supported on the same or separate supports, or one or more of the components may be used in an unsupported form. One or more embodiments provide that the non-metallocene complex represented by Formula II is supported, while the Zr metal-ligand complex of Formula I is unsupported, i.e., the Zr metal-ligand complex of Formula I is utilized as part of a trim catalyst solution. Utilizing the support may be accomplished by any technique used in the art. One or more embodiments provide that a spray dry process is utilized. Spray dry processes are well known in the art. The support may be functionalized.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. One or more embodiments provide that the support is silica. One or more embodiments provide that the support is hydrophobic fumed silica. One or more embodiments provide that the support is dehydrated silica. Additional support materials may include porous acrylic polymers, nanocomposites, aerogels, spherulites, and polymeric beads. An example of a support is fumed silica available under the trade name CABOSIL TS-610, or other TS- or TG-series supports, available from Cabot Corporation. Fumed silica is typically a silica with particles 7 to 30 nanometers in size that has been treated with dimethylsilyldichloride such that a majority of the surface hydroxyl groups are capped.

The support material may have a surface area in the range of from about 10 to about 700 m/g, pore volume in the range of from about 0.1 to about 4.0 g/cm³ and average particle size in the range of from about 5 to about 500 μm. More preferably, the surface area of the support material is in the range of from about 50 to about 500 m/g, pore volume of from about 0.5 to about 3.5 g/cm³ and average particle size of from about 10 to about 200 μm. Most preferably the surface area of the support material is in the range is from about 100 to about 400 m/g, pore volume from about 0.8 to about 3.0 g/cm³ and average particle size is from about 5 to about 100 μm. The average pore size of the carrier typically has pore size in the range of from 10 to I000 A, preferably 50 to about 500 A, and most preferably 75 to about 350 A.

As mentioned, one or more embodiments provide that a spray dry process is utilized, e.g., to make a spray-dried composition. As used herein, “spray-dried composition” refers to a composition that includes a number of components that have undergone a spray-drying process. Various spray-drying process are known in the art and are suitable for forming the spray-dried compositions discussed herein. One or more embodiments provide that the spray-dried composition can be utilized with a trim composition to make bimodal polymers.

In one or more embodiments, the spray-drying process may comprise atomizing a composition including the non-metallocene complex of Formula II and/or an activator. A number of other known components may be utilized in the spray-drying process. An atomizer, such as an atomizing nozzle or a centrifugal high speed disc, for example, may be used to create a spray or dispersion of droplets of the composition. The droplets of the composition may then be rapidly dried by contact with an inert drying gas. The inert drying gas may be any gas that is non-reactive under the conditions employed during atomization, such as nitrogen, for example. The inert drying gas may meet the composition at the atomizer, which produces a droplet stream on a continuous basis. Dried particles of the composition may be trapped out of the process in a separator, such as a cyclone, for example, which can separate solids formed from a gaseous mixture of the drying gas, solvent, and other volatile components.

A spray-dried composition may have the form of a free-flowing powder, for instance. After the spray-drying process, the spray-dried composition and a number of known components may be utilized to form a slurry. The spray-dried composition may be utilized with a diluent to form a slurry suitable for use in olefin polymerization, for example. In one or more embodiments, the slurry, which includes the spray-dried non-metallocene complex of Formula II and the activator, may be combined with one or more additional catalysts, e.g., the unsupported Zr metal-ligand complex of Formula I, and/or other known components prior to delivery into a polymerization reactor.

In one or more embodiments, a composition may be formed by contacting a spray dried particle, such as spray dried non-metallocene complex of Formula II and MAO, with a solution of the Zr metal-ligand complex of Formula I. A solution of Zr metal-ligand complex of Formula I typically may be made in an inert hydrocarbon solvent, for instance, and can be referred to as a trim solution. Such a composition comprised of contacting the trim solution of the Zr metal-ligand complex of Formula I with a spray dried particle, such as spray-dried non-metallocene complex of Formula II and MAO, may be made in situ in a feed line heading into a gas phase polymerization reactor by contacting the trim solution with a slurry, typically in mineral oil, of the spray-dried activator particle.

Various spray-drying conditions may be utilized for different applications. For instance, the spray-drying process may utilize a drying temperature from 115 to 185° C. Various sizes of orifices of the atomizing nozzle employed during the spray-drying process may be utilized to obtain different particle sizes. Alternatively, for other types of atomizers such as discs, rotational speed, disc size, and number/size of holes may be adjusted to obtain different particle sizes. One or more embodiments provide that a filler may be utilized in the spray-drying process. Different fillers and amounts thereof may be utilized for various applications.

The compositions, as disclosed herein, e.g., including the Zr metal ligand-complex of Formula I, the non-metallocene complex of Formula II, the activator, and the support, can be utilized for making bimodal polymers, e.g., bimodal polyolefin compositions. One or more embodiments provide that the polymers are made utilizing a gas-phase reactor system. One or more embodiments provide that a single gas-phase reactor, e.g., in contrast to a series of reactors, is utilized. In other words, polymerization reaction occurs in only one reactor. For instance, the polymers can be made utilizing a fluidized bed reactor. Gas-phase reactors are known and known components and conditions may be utilized for making the bimodal polymers.

The polyolefin compositions discussed herein are bimodal, e.g., in contrast to unimodal. As used herein, “unimodal” refers to polymers that can be characterized by having one peak in a GPC chromatogram showing the molecular weight distribution. Furthermore, a unimodal composition is a composition that is made by utilizing a single catalyst, e.g., a single polyethylene catalyst. This distinguishes the unimodal composition, as defined above, from bimodal compositions that may appear to have one peak in the GPC chromatogram showing the molecular weight distribution. These bimodal compositions are those that are made by utilizing the Zr metal ligand-complex of Formula I and the non-metallocene complex of Formula II. Additionally, the Zr metal ligand-complex of Formula I and the non-metallocene complex of Formula II in a single gas phase reactor may produce a bimodal polymer that appears to have a single peak in a GPC chromatogram showing the molecular weight distribution. This would also be defined as a bimodal polymer composition.

As used herein an “olefin,” which may be referred to as an “alkene,” refers to a linear, branched, or cyclic compound including carbon and hydrogen and having at least one double bond. As used herein, when a polyolefin, polymer, and/or copolymer is referred to as comprising, e.g., being made from, an olefin, the olefin present in such polymer or copolymer is the polymerized form of the olefin. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer. A higher α-olefin refers to an α-olefin having 3 or more carbon atoms.

Bimodal polyolefins made with the compositions disclosed herein can made from olefin monomers such as ethylene, i.e., polyethylene, and linear or branched higher alpha-olefin monomers containing 3 to 20 carbon atoms. Examples of higher alpha-olefin monomers include, but are not limited to, propylene, butene, pentene, 1-hexene, and 1-octene. Examples of polyolefins include ethylene-based polymers, having at least 50 wt % ethylene, including ethylene-1-butene, ethylene-1-hexene, and ethylene-1-octene copolymers, among others. One or more embodiments provide that the polymer can include from 50 to 99.9 wt % of units derived from ethylene based on a total weight of the polymer. All individual values and subranges from 50 to 99.9 wt % are included; for example, the polymer can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the polymer. The polymer can include from 0.1 to 50 wt % of units derived from comonomer based on the total weight of the polymer. One or more embodiments provide that ethylene is utilized as a monomer and hexene is utilized as a comonomer.

The bimodal polyolefin compositions discussed herein can have a weight average molecular weight (Mw) from 100,000 to 700,000 g/mol. All individual values and subranges from 100,000 to 700,000 g/mol are included; for example, the polyolefin composition can have an Mw from a lower limit of 100,000, 120,000, 150,000, or 200,000 g/mol to an upper limit of 700,000, 650,000, or 500,000 g/mol. Mw can be determined by gel permeation chromatography (GPC), as is known in the art. GPC is discussed herein.

The bimodal polyolefin compositions discussed herein can have a number average molecular weight (Mn) from 5,000 to 100,000 g/mol. All individual values and subranges from 5,000 to 100,000 g/mol are included; for example, the polyolefin composition can have an Mn from a lower limit of 5,000, 8,000, or 10,000 g/mol to an upper limit of 100,000, 75,000 or 50,000 g/mol. Mn can be determined by GPC.

The bimodal polyolefin compositions discussed herein can have a Z-average molecular weight (Mz) from 1,000,000 to 7,000,000 g/mol. All individual values and subranges from 1,000,000 to 7,000,000 g/mol are included; for example, the polyolefin composition can have an Mz from a lower limit of 1,000,000, 1,350,000, or 2,000,000 g/mol to an upper limit of 7,000,000, 6,500,000, or 4,750,000 g/mol. Mz can be determined by GPC.

The bimodal polyolefin compositions discussed herein can have a weight average molecular weight to number average molecular weight ratio (Mw/Mn) from 10 to 30. All individual values and subranges from 10 to 30 are included; for example, the polyolefin composition can have an Mw/Mn from a lower limit of 10, 12, or 15 to an upper limit of 30, 28, or 25. Mw/Mn may also be referred to as molecular weight distribution or “MWD”.

The bimodal polyolefin compositions discussed herein can have a density from 0.925 to 0.990 g/cm³. All individual values and subranges from 0.925 to 0.990 g/cm³ are included; for example, the polyolefin composition can have a density from a lower limit of 0.925, 0.930, or 0.935 g/cm³ to an upper limit of 0.990, 0.980, or 0.970 g/cm³. Density can be determined by according to ASTM D792.

The bimodal polyolefin compositions discussed herein can have a high molecular weight split (% HMW) from 40 to 70%. All individual values and subranges from 40 to 70% are included; for example, the polyolefin composition can have a % HMW from a lower limit of 40, 42, or 45% to an upper limit of 70, 65, or 60%. As used herein, split, or reactor split, refers to respective weight fractions of a particular resin component in the bimodal polymer (e.g., the bimodal polymer produced in a single-stage gas-phase reactor). Split can be determined by GPC.

The bimodal polymers can be made in a reactor, e.g., a fluidized bed reactor. The reactor can have a reaction temperature from 10 to 130° C. All individual values and subranges from 10 to 130° C. are included; for example, the fluidized bed reactor can have a reaction temperature from a lower limit of 10, 20, 30, 40, 50, or 55° C. to an upper limit of 130, 120, or 110° C.

One or more embodiments provide that ethylene is utilized as a monomer and hexene is utilized as a comonomer. The reactor can have a comonomer to ethylene mole ratio, e.g., C₆/C₂, from 0.0001 to 0.100. All individual values and subranges from 0.0001 to 0.100 are included; for example, the reactor can have a comonomer to ethylene mole ratio from a lower limit of 0.0001, 0.0005, or 0.0007 to an upper limit of 0.100, or 0.080.

When hydrogen is utilized for a polymerization process, the reactor can have a hydrogen to ethylene mole ratio (H₂/C₂) from 0.00001 to 0.90000, for instance. All individual values and subranges from 0.00001 to 0.90000 are included; for example, the reactor can have a H₂/C₂ from a lower limit of 0.00001, 0.00005, or 0.00008 to an upper limit of 0.90000, 0.500000, 0.10000, 0.01500, 0.00700, or 0.00500. One or more embodiments provide that hydrogen is not utilized.

Advantageously, the bimodal polymers made utilizing the Zr metal-ligand complex of Formula I and the non-metallocene complex of Formula II discussed herein can have an improved, i.e., reduced, total oligomer, as compared to polymers formed with other metallocene compositions at similar polymerization conditions. Reduced total oligomer is desirable for a number of applications.

### EXAMPLES

Metallocene complex 1: (methyl cyclopentadienyl)(1,3-dimethyl hexahydroazulenyl) zirconium dimethyl was obtained from The Dow Chemical Company.

Non-Metallocene complex 1: bis(2-(pentamethylphenylamido)ethyl)-amine zirconium dibenzyl.

Comparative Metallocene A, which may be represented by the following formula:

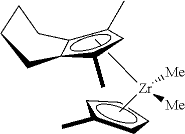

was obtained from The Dow Chemical Company.

Activator: methylaluminoxane.

Support: CAB-O-SIL TS-610 hydrophobic fumed silica was obtained from CABOT.

Hexane: A hydrocarbon solvent primarily consisting of n-hexane (C₆H₁₄) and other isomers (2-methylpentane and 3-methylpentane) and minor constituents such as methylcyclopentane. May be used as a solvent for metallocene catalysts or added to Bimodal Catalyst System preparations to reduce foaming.

Preparation of Spray-dried Composition 1 (SDC1): A polymerization catalyst system was prepared by slurrying 1.5 kg of treated fumed silica in 16.8 kg of toluene, followed by addition of a 10% solution (11.1 kg) by weight of MAO in toluene and 54.5 g of bis(2-(pentamethylphenylamido)ethyl)-amine zirconium dibenzyl complex. The resulting mixture is introduced into an atomizing device, producing droplets that are then contacted with a hot nitrogen gas stream to evaporate the liquid and form a powder. The powder is separated from the gas mixture in a cyclone separator and discharged into a container. The spray drier temperature is set at 160° C. and the outlet temperature at 70-80° C. The product collected is a fine powder. The resultant powder is then slurried to a final formulation of 16 wt % solids in 10 wt % n-hexane and 74 wt % Sonneborn HYDROBRITE 380 PO White mineral oil.

Preparation of Spray-dried Composition 2 (SDC2): A polymerization catalyst system was prepared by slurrying 1.4 kg of treated fumed silica in 11.4 kg of toluene, followed by addition of a 10% solution (15.1 kg) by weight of MAO in toluene and 69.9 g of bis(2-(pentamethylphenylamido)ethyl)-amine zirconium dibenzyl complex and 12.6 g of Metallocene complex 1. The resulting mixture is introduced into an atomizing device, producing droplets that are then contacted with a hot nitrogen gas stream to evaporate the liquid and form a powder. The powder is separated from the gas mixture in a cyclone separator and discharged into a container. The spray drier temperature is set at 160° C. and the outlet temperature at 70-80° C. The product collected is a fine powder. The resultant powder is then slurried to a final formulation of 20 wt % solids in 10 wt % n-hexane and 70 wt % Sonneborn HYDROBRITE 380 PO White mineral oil.

Preparation of Spray-dried Composition 3 (SDC3): A polymerization catalyst system was prepared by slurrying 145 kg of treated fumed silica in 2,321 kg of toluene, followed by addition of a 30% solution (469 kg) by weight of MAO in toluene and 7.3 kg of bis(2-(pentamethylphenylamido)ethyl)-amine zirconium dibenzyl complex and 12.2 kg of a 10.3 wt % solution in hexane of Comparative Metallocene A. The resulting mixture is introduced into an atomizing device, producing droplets that are then contacted with a hot nitrogen gas stream to evaporate the liquid and form a powder. The powder is separated from the gas mixture in a cyclone separator and discharged into a container. The spray drier temperature is set at 163° C. and the outlet temperature at 83° C. The product collected is a fine powder. The resultant powder is then slurried to a final formulation of 21.4 wt % solids in 11.9 wt % Isopar C and 66.7 wt % Sonneborn HYDROBRITE 380 PO White mineral oil.

Preparation of Trim Catalyst Solution 1 (“TCS1”) comprising a trim solution of Metallocene Complex 1 in hexane and isopentane. Charge 938 grams of a 1.08 Wt % solution of Metallocene Complex 1 in hexane into a first cylinder. Charge the resulting solution of Metallocene Complex 1 solution in hexane from the first cylinder into a 106 liter (L; 28 gallons) second cylinder. Added 24.36 kg (53.7 pounds) of high purity isopentane to the 106 L cylinder to yield the Trim Catalyst Solution 1 of 0.04 wt % Metallocene Complex 1 in hexane and isopentane.

Preparation of Trim Catalyst Solution 2 (“TCS2”) comprising a trim solution of Comparative Metallocene Complex A in hexane and isopentane. Charge 43.13 grams of a 10.5 Wt % solution of Comparative Metallocene Complex A in hexane into a first cylinder. Charge the resulting solution of Comparative Metallocene Complex A solution in hexane from the first cylinder into a 106 liter (L; 28 gallons) second cylinder. Added 11.29 kg (24.9 pounds) of high purity isopentane to the 106 L cylinder to yield the Trim Catalyst Solution 2 of 0.04 wt % Comparative Metallocene Complex A in hexane and isopentane.

Preparation of Trim Catalyst Solution 3 (“TCS3”) comprising a trim solution of Comparative Metallocene Complex A in hexane and isopentane. Charge 69.2 grams of a 10.5 Wt % solution of Comparative Metallocene Complex A in hexane into a first cylinder. Charge the resulting solution of Comparative Metallocene Complex A solution in hexane from the first cylinder into a 106 liter (L; 28 gallons) second cylinder. Added 18.10 kg (39.9 pounds) of high purity isopentane to the 106 L cylinder to yield the Trim Catalyst Solution 3 of 0.04 wt % Comparative Metallocene Complex A in hexane and isopentane.

Polymerization Procedure. For Example 1 described below, copolymerized ethylene and 1-hexene using the Spray Dried Catalyst 1 (SDC1) and a controlled relative amount of Trim Catalyst Solution 1 in a fluidized bed-gas phase polymerization (FB-GPP) reactor having a distribution grid to make an embodiment of the bimodal poly(ethylene-co-1-alkene) copolymer that is a bimodal poly(ethylene-co-1-hexene) copolymer. For Inventive Example 2 described below, copolymerized ethylene and 1-hexene using the Spray Dried Catalyst 2 (SDC2) and a controlled relative amount of Trim Catalyst Solution 1 in a fluidized bed-gas phase polymerization (FB-GPP) reactor having a distribution grid to make an embodiment of the bimodal poly(ethylene-co-1-alkene) copolymer that is a bimodal poly(ethylene-co-1-hexene) copolymer. For the Comparative Examples 1 and 2 described below, copolymerized ethylene and 1-hexene using the Spray Dried Catalyst 3 (SDC3) and a controlled relative amount of Trim Catalyst (TCS2 or TCS3) in a fluidized bed-gas phase polymerization (FB-GPP) reactor having a distribution grid to make an a bimodal poly(ethylene-co-1-alkene) copolymer that is a bimodal poly(ethylene-co-1-hexene) copolymer. Trim Catalyst Solutions contacted Slurry form of Spray Dried Catalyst System in line on way to reactor, mixed with static mixer prior to injection into reactor with nitrogen carrier. The FB-GPP reactor had a 0.35 meter (m) internal diameter and 2.3 m bed height and a fluidized bed composed of polymer granules. Flowed fluidization gas through a recycle gas loop comprising sequentially a recycle gas compressor and a shell-and-tube heat exchanger having a water side and a gas side. The fluidization gas flows through the compressor, then the tube side of the shell-and-tube heat exchanger, then into the FB-GPP reactor below the distribution grid. Fluidization gas velocity in the bed is about 0.55 to 0.67 meter per second (m/s, 1.8 to 2.2 feet per second). The fluidization gas then exits the FB-GPP reactor through a nozzle in the top of the reactor, and is recirculated continuously through the recycle gas loop. Maintained a constant fluidized bed temperature as indicated in Table 1 and 2 by continuously adjusting the temperature of the water on the shell side of the shell-and-tube heat exchanger. Introduced feed streams of ethylene, nitrogen, and hydrogen together with the 1-hexene comonomer into the recycle gas line. Operated the FB-GPP reactor at a total pressure of about 2413 kPa gauge, and vented reactor gases to a flare to control the total pressure. Adjusted individual flow rates of ethylene, nitrogen, hydrogen and the 1-hexene to maintain their respective gas composition targets. Set ethylene partial pressure to 1.52 megapascal (MPa, 220 pounds per square inch (psi)), and set the C6/C2 molar ratio and the H2/C2 molar ratio per Table 1. Maintained isopentane (ICA) concentration at about 12.0-13.0 mol %. Average copolymer residence time was about 2.0 to 3.0 hours. Measured concentrations of all gasses using an on-line gas chromatograph. Maintained the fluidized bed at constant height by withdrawing a portion of the bed at a rate equal to the rate of formation of particulate product bimodal poly(ethylene-co-1-hexene) copolymer. Product was removed semi-continuously via a series of valves into a fixed volume chamber. A nitrogen purge removed a significant portion of entrained and dissolved hydrocarbons in the fixed volume chamber. After purging, the product was discharged from the fixed volume chamber into a fiber pack for collection. The product was further treated with a small stream of humidified nitrogen to deactivate any trace quantities of residual catalyst and cocatalyst. Set the ratio feed of trim catalyst solution TCS to the feed of the slurry catalyst to adjust the HLMI (I21) of the produced bimodal poly(ethylene-co-1-hexene) copolymer in the reactor to target values. Set the catalyst feeds at rates sufficient to maintain a production rate of about 13.6 to about 21 kg/hour (about 30 to about 46 lbs/hr) of the bimodal poly(ethylene-co-1-hexene) copolymer.

Polymerization conditions are reported in the following Tables.

TABLE 1

| | | Polymerization 2 | | Polymerization 4 |
|---|---|---|---|---|
| | Polymerization 1 | (Comparative | Polymerization 3 | (Comparative |
| | (Example 1) | Example A) | (Example 2) | Example B) |
| Spray-Dried | Spray-dried | Spray-dried | Spray-dried | Spray-dried |
| Composition | composition 1 | composition 1 | composition 2 | composition 3 |
| Trim | Metallocene | Comparative | Metallocene | Comparative |
| Component | complex 1 | Metallocene A | complex 1 | Metallocene A |
| | (TCS1) | (TCS2) | (TCS1) | (TCS3) |
| Trim/ Spray- | 10.0 | 9.3 | 10.8 | 10.4 |
| dried | | | | |
| composition 1 | | | | |
| ratio | | | | |
| (lb/lb) | | | | |
| Reaction Temp | 100 | 100 | 100 | 100 |
| (° C.) | | | | |
| C₆/C₂ | 0.006 | 0.006 | 0.007 | 0.006 |
| (molar ratio) | | | | |
| H₂/C₂ | 0.0023 | 0.0023 | 0.0023 | 0.0023 |
| (molar ratio) | | | | |
| Mass balance | 17,117 | 15,569 | 10,823 | 9,567 |
| productivity (lb | | | | |
| PE/lb catalyst) | | | | |
| Mn | 16,523 | 18,956 | 15,240 | 17,391 |
| Mw | 352,658 | 373,695 | 353,845 | 368,732 |
| Mz | 4,087,828 | 4,396,572 | 4,110,181 | 4,297,829 |
| Mw/Mn | 21.34 | 19.71 | 23.22 | 21.20 |
| Melt Index | 0.22 | 0.19 | 0.22 | 0.21 |
| (I₅) | | | | |
| Melt Index | 8.20 | 6.16 | 6.88 | 6.28 |
| (I₂₁) | | | | |
| Extruded | 0.9498 | 0.9490 | 0.9486 | 0.9486 |
| density | | | | |
| (g/cm³) | | | | |
| Oligomer | 767 | 1234 | 590 | 1107 |
| C₁₀-C₁₆ | | | | |
| (ppm) | | | | |
| Total Oligomer | 777 | 1274 | 625 | 1133sp |
| C₆-C₁₆ | | | | |
| (ppm) | | | | |
| Split | 46.60 | 46.15 | 50.63 | 51.16 |
| (% HMW) | | | | |
| Mp | 21,878 | 25,704 | 20,417 | 23,422 |
| LMW | | | | |
| Mp | 301,995 | 309,029 | 269,153 | 275,423 |
| HMW | | | | |
| Spread | 280,117 | 283,325 | 248,736 | 251,981 |

The data of Table 1 show that the polymer formed utilizing Examples 1-2 had improved, i.e., reduced, total oligomer as compared to polymers formed utilizing Comparative Examples A-B.

### Gel Permeation Chromatography (GPC).

Mw, Mn, Mz, and Mw/Mn (PDI) were determined by using a High Temperature Gel Permeation Chromatography (Polymer Laboratories), equipped with a differential refractive index detector (DRI). Three Polymer Laboratories PLgel 10 μm Mixed-B columns were used. The nominal flow rate is 1.0 mL/min, and the nominal injection volume is 300 μL. The various transfer lines, columns, and differential refractometer (the DRI detector) are contained in an oven maintained at 160° C. Solvent for the experiment was prepared by dissolving 6 grams of butylated hydroxytoluene as an antioxidant in 4 liters of Aldrich reagent grade 1, 2, 4 trichlorobenzene (TCB). The TCB mixture was then filtered through a 0.1 μm Teflon filter. The TCB was then degassed with an online degasser before entering the GPC instrument. Polymer solutions were prepared by placing dry polymer in glass vials, adding the desired amount of TCB, then heating the mixture at 160° C. with continuous shaking for about 2 hours. All quantities were measured gravimetrically. The injection concentration was from 0.5 to 2.0 mg/ml, with lower concentrations being used for higher molecular weight samples. Prior to running each sample the DRI detector was purged. Flow rate in the apparatus was then increased to 1.0 ml/minute, and the DRI was allowed to stabilize for 8 hours before injecting the first sample. The molecular weight was determined by combining universal calibration relationship with the column calibration which is performed with a series of monodispersed polystyrene (PS) standards. The MW was calculated at each elution volume with following equation:

$$log {M}_{X} = \frac{log ( {K}_{X} / {K}_{PS} )}{{a}_{X} + 1} + \frac{{a}_{PS} + 1}{{a}_{X} + 1} log {M}_{PS}$$

where the variables with subscript “X” stand for the test sample while those with subscript “PS” stand for PS. In this method, a_{PS}=0.67 and K_{PS}=0.000175 while a_{X} and K_{X} are obtained from published literature. Specifically, a/K=0.695/0.000579 for PE and 0.705/0.0002288 for PP.

The concentration, c, at each point in the chromatogram is calculated from the baseline-subtracted DRI signal, IDRI, using the following equation:

c=K_{DRI}I_{DRI}/(dn/dc), where K_{DRI} is a constant determined by calibrating the DRI, and (dn/dc) is the refractive index increment for the system. Specifically, dn/dc=0.109 for polyethylene. The mass recovery is calculated from the ratio of the integrated area of the concentration chromatography over elution volume and the injection mass which is equal to the pre-determined concentration multiplied by injection loop volume. All molecular weights are reported in g/mol unless otherwise noted. In event of conflict between the GPC-DRI procedure and the “Rapid GPC,” the GPC-DRI procedure immediately above shall be used.

Comonomer content (i.e., 1-hexene) incorporated in the polymers (weight %) was determined by rapid FT-IR spectroscopy on the dissolved polymer in a GPC measurement. Comonomer content can be determined with respect to polymer molecular weight by use of an infrared detector such as an IR5 detector in a gel permeation chromatography measurement, as described in Analytical Chemistry 2014, 86(17), 8649-8656. “Toward Absolute Chemical Composition Distribution Measurement of Polyolefins by High-Temperature Liquid Chromatography Hyphenated with Infrared Absorbance and Light Scattering Detectors” by Dean Lee, Colin Li Pi Shan, David M. Meunier, John W. Lyons, Rongjuan Cong, and A. Willem deGroot. Analytical Chemistry 2014 86 (17), 8649-8656.

### Melt Index.

Melt flow index of polyethylene and copolymers was measured via the rate of extrusion of molten polymers through a die of specified length and diameter, under prescribed conditions of temperature, load, piston position in the barrel and duration. The experiments are carried out employing a melt indexer and according to ASTM D 3418-08 method.

1. A composition for making a bimodal polyolefin polymer comprising:
a zirconium metal-ligand complex of Formula I: 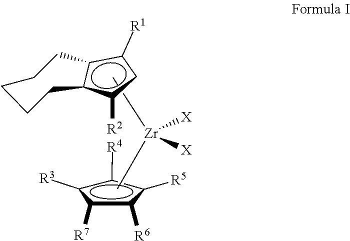
wherein R¹ and R² are each independently a (C₁-C₈)alkyl, and R³, R⁴, R⁵, R⁶, R⁷ are each independently H or a (C₁-C₈)alkyl, with the proviso that at least one of R³, R⁴, R⁵, R⁶, R⁷ is a (C₁-C₈)alkyl; and each X is independently a leaving group;
a non-metallocene complex;
an activator; and
a support.

2. The composition of claim 1, wherein the non-metallocene complex is a bis(2-(pentamethylphenylamido)ethyl)-amine zirconium complex of Formula II: 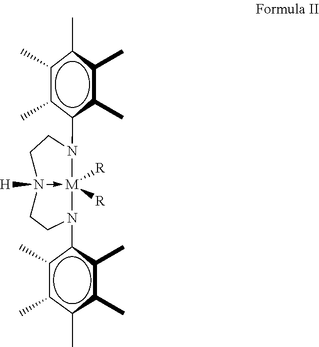
wherein M is Zr or Hf and each R independently is Cl, Br, a (C₁ to C₂₀) alkyl, a (C₁ to C₆) alkyl-substituted (C₆-C₁₂) aryl, benzyl, or a (C₁ to C₆) alkyl-substituted benzyl.

3. The composition of claim 1, wherein the zirconium metal-ligand complex is (methyl cyclopentadienyl)(1,3-dimethyl hexahydroazulenyl) zirconium dimethyl of Formula III

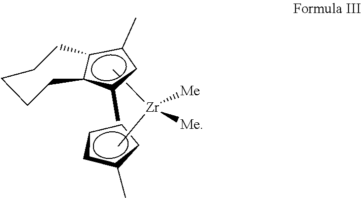

4. The composition of claim 1, wherein the non-metallocene complex is bis(2-(pentamethylphenylamido)ethyl)-amine zirconium dibenzyl.

5. The composition of claim 1, wherein the activator is methylaluminoxane.

6. The composition claim 1, wherein the support is silica.

7. The composition of claim 1, wherein the Zr metal ligand-complex of Formula I is from 20 to 80 weight percent of the composition based upon a total weight of the zirconium metal-ligand complex of Formula I and the non-metallocene complex.

8. The composition of claim 1, wherein the non-metallocene complex is from 20 to 80 weight percent of the composition based upon the total weight of the zirconium metal-ligand complex of Formula I and the non-metallocene complex.

9. The composition of claim 1, wherein a molar ratio of metal in the activator to Group IV metal in the Zr metal-ligand complex of Formula I and the non-metallocene complex is from 1500:1 to 0.5:1.

10. The composition of claim 1, wherein the non-metallocene complex, the activator, the support, and optionally the Zr metal ligand-complex of Formula 1 are spray dried.

11. A method of making a polyolefin polymer, the method comprising:
contacting, under polymerization conditions, an olefin with the composition of claim 1 so as to polymerize the olefin, thereby making a polyolefin polymer.

12. The method of claim 11, wherein in the polyolefin polymer is a bimodal polyolefin polymer.
